(19) United States
(12) Patent Application Publication
(10) Pub. No.: US 2006/0047794 A1
(43) Pub. Date: Mar. 2, 2006

(54) Application of genetic algorithms to computer system tuning

(75) Inventor: Eduardo Jezierski, Sammamish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/933,655

(22) Filed: Sep. 2, 2004

(51) Int. Cl. G06F 15/177

(52) U.S. Cl. 709/221

(57) ABSTRACT

The software and/or hardware components of a multi-purposed computer system may be tuned by using a genetic algorithm. The genetic algorithm may be used to optimize a plurality of configuration parameters of the components of the computer system.

### TECHNICAL FIELD

This application is directed to tuning a computer system, and more particularly, to tuning the configuration parameters of a multi-purposed computer system using genetic algorithms.

### BACKGROUND

Computer systems are typically made up of many system components, including, for example, computer processing units, applications, storage units, communication ports and other networking components, operating systems, protocol stacks, thread pools, message queues (in memory and persistent), memory allocators, memory garbage collectors, intermediate-language compilers, and other hardware and software components. Each computer system component may have one or more configuration parameters which are exposed by the computer system component to allow changing the behavior of the computer system. The configuration parameters may be individually adjusted to tune each component to optimize the computer system environment towards a desired behavior. However, in existing approaches, the design and the adjustment of each configuration parameter is achieved through iterative manual trial-and-error calculations or speculative performance simulations. For example, a component tuner may change a component configuration parameter and then test and/or predict the component performance. However, the selection of the values for the configuration parameters for each iteration is manually left to the tuning expert and is often based on that expert's interpretation of one or more previous iterations. In some cases, computer system tuning experts have developed rules of thumb or heuristics based on previous experience; however, these heuristics are generally specific to a particular component.

In other approaches, optimization tools have been used with some specific performance systems to reduce the manual emphasis on performance tuning. However, these optimizers are typically designed for an individual system component and are often integrated into a specific simulator or test workbench for that individual component.

### SUMMARY

The following presents a simplified summary of the disclosure in order to provide a basic understanding to the reader. This summary is not an exhaustive or limiting overview of the disclosure. The summary is not provided to identify key and/or critical elements of the invention, delineate the scope of the invention, or limit the scope of the invention in any way. Its sole purpose is to present some of the concepts disclosed in a simplified form, as an introduction to the more detailed description that is presented later.

Although heuristic and optimizer tool-based tuning may optimize the configuration parameters for each individual component of a computer system, tuning of each individual and often heterogeneous component may not necessarily lead to tuning of the system as a whole. More particularly, piecewise component tuning in complex computer systems does not map to overall system tuning. This complexity is increased in a computer system environment that not only includes components sold by different vendors requiring in-depth knowledge of a plurality of components, but a computer system may also include heterogeneous computer components, e.g., either different types of components or components with different configuration parameters. Since, the tuning of computer system components in the prior art typically requires extensive knowledge of the component, one expert tuner for one component may not know anything about another system component which may also need to be tuned. Despite the system complexity, there is a need to tune the computer system as a collection of components to improve the interoperability of the system components, the performance or speed of the system, the security of the system, the scalability of the system, and/or any other quantifiable system attribute.

The application is directed toward tuning a computer system using genetic algorithms. Specifically, a multi-purposed computer system having at least two computer system components may be tuned by optimizing a plurality of configuration parameters of the multi-purposed computer system using a genetic algorithm. As used herein, the definition of optimizing is improving a behavior of the computer system towards a desired goal. A multi-purposed computer system as used herein means a computer system comprising multiple computer system components and at least two of the components have different purposes. The purpose of a computer system component is the object or end to be attained or maintained. For example, the purpose of a database may be to provide and store information, a communication port's purpose may be to transfer information, and middleware software's purpose may be to activate, execute, and prioritize units of work to be done.

In some cases, the genetic algorithm may generate a first configuration parameter for a first software component and a second configuration parameter for a second software component of the computer system. The first and second configuration parameters may be used to define the response of the computer system, e.g., in terms of performance, scalability, security, interoperability, and/or any other desired behavior of the computer system. The response may then be evaluated or compared to the desired response of the system. For example a stress testing component may be used to generate user behavior as input into the actual or simulated computer system components defined by the generated configuration parameters. The simulated or actual system components may then generate a quantifiable attribute of the system, which as noted above may include system performance, security, scalability, etc. The quantifiable attribute may be evaluated, and based upon that evaluation, the genetic algorithm may be used to modify at least one of the configuration parameters to tune the computer system as a whole.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a dataflow diagram of an example system for tuning a computer system in ne embodiment;

FIG. 2 is a diagram of an example multi-purpose computer system of FIG. 1;

FIG. 3 is a diagram of another example multi-purpose computer system of FIG. 1;

FIG. 4 is a flow chart describing a cycle of a genetic algorithm optimization process of the prior art;

FIG. 5 is a flow chart describing an example process of applying a genetic algorithm as an optimizer in one embodiment;

FIG. 6 is a flow chart describing an example problem definition of FIG. 5;

FIG. 7 is a flow chart describing an example solution setting definition of FIG. 5;

FIG. 8 is a flow chart describing an example running of a solution of FIG. 5; and

FIG. 9 is a diagram of an exemplary system useful for implementing an embodiment of the system of FIG. 1.

### DETAILED DESCRIPTION

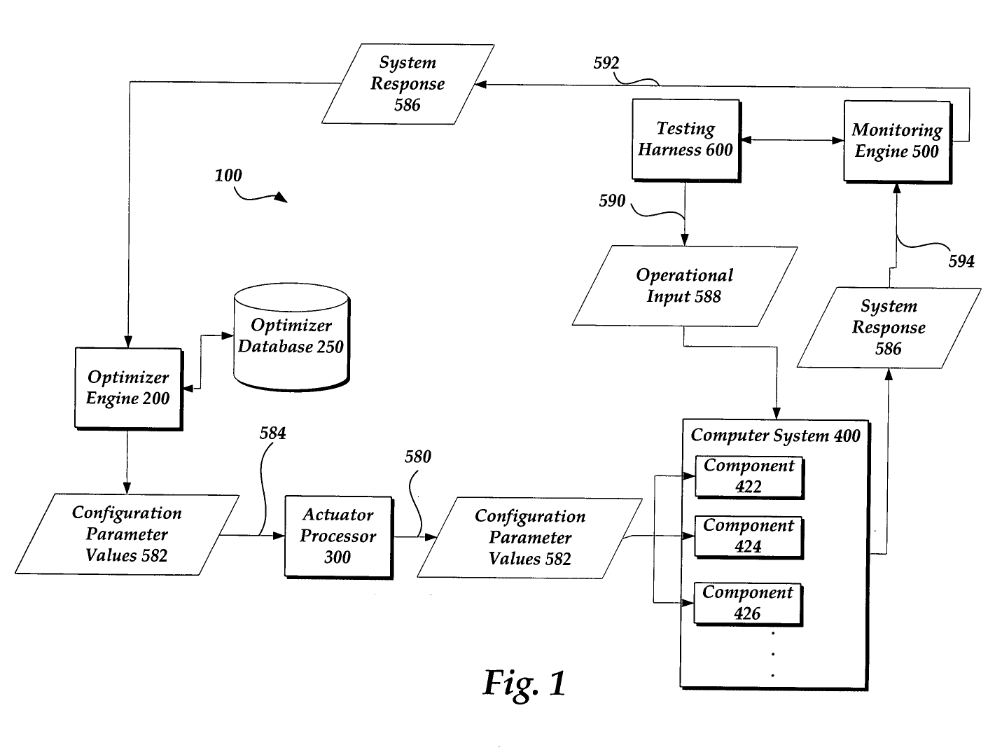

FIG. 1 illustrates an example system for tuning a computer system. The tuning system 100 includes a computer system 400 which is made up of a plurality of computer system components 422, 424, 426, etc. The components of the computer system may include, but are not limited to, a computer processing unit, an application, a storage unit, a communication port and/or other networking component, an operating system, and/or other hardware and software components in a multi-component computer system. Each component may have at least one configuration parameter which may change how that component operates without changing the semantics of the overall computer system. Each computer system component may have any number of component parameters as determined by the component developer. Each individual component parameter may be a network parameter, capacity parameter, availability parameter, performance parameter, security parameter and/or any other parameter type, depending on the system components within the computer system. Although three components are illustrated in computer system 400 of FIG. 1 and each having only one configuration parameter, it is to be appreciated that the computer system 400 may include one or more components which may be of the same or different type and each component may have any number and type of configuration parameters.

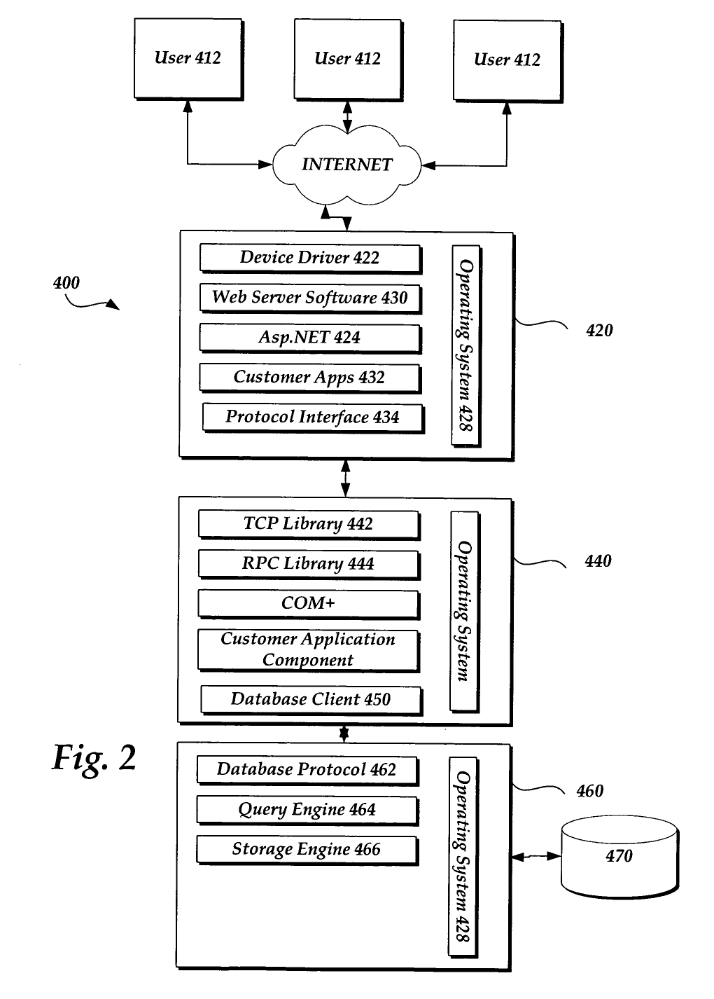

An example multi-purposed computer system 400 is shown in FIG. 2 and may include a variety of processing entities, each having a combination of computer system components. As shown in FIG. 2, the computer system 400 may be a computer system hosting an e-commerce web site. The computer system 400 may include a web server 420 which may present a web page accessible by host users 412 through a network, such as the Internet. The web page may provide information to the host user such as a catalog of products for sale, and may also accept information from the host user such as purchasing information from the user. Web servers are known in the art and may include a Microsoft IIS server and an Apache server.

As shown in FIG. 2, the web server may provide an interface to the network such as the Internet to permit one or more host computers access to the site at the same time. The web server 420 may include one or more components including device drivers 422, web server software 424, and/or protocol interface 426. The web server software 424 may include an operating system 428 such as Microsoft WINDOWS SERVER 2003; a server application infrastructure such as Microsoft's Internet Information Server (“IIS”); a server- side scripting application which generates the text, graphics, and interactive objects of a web site with templates for dynamic page creation such as Microsoft's ASP.NET, and various customer applications. Examples, of customer applications may include software applications specific to that business entity built by the customer or a third party software vendor. The web server 420 components may access an application server 440 of the computer system 400 through a protocol interface 434 which may include a TCP interface or any other appropriate protocol interface. The web server components may have a variety of configuration parameters including HTTP buffer size, number of input/output threads, input/output connections, number of worker processes, maximum pool threads, virtual memory size, maximum number connections, maximum number of worker threads, minimum number of free threads, minimum number of local request free threads, timeout number, deadlock number, queue size, memory threshold, protocol window size, protocol memory window scaling, protocol hash table size, maximum protocol user ports, number input/output count operations, number of input/output requests and/or any other suitable configuration parameter of the components of the web server. The operating system 428 may have any appropriate configuration parameter including virtual memory allocation and thread scheduling algorithms. For example, the maximum number of pool threads may be an integer value bounded within the range of 20 to 100. One or more of the boundaries of the range may be constrained by the component itself. However, it is to be appreciated that one or more of the boundaries may be constrained within the optimizer engine 20 (discussed further below) to limit the values considered in the optimization.

The application server 440 of the computer system 400 of FIG. 2 may provide application components which may provide a ‘back-end’ functionality to the web server by providing processing, scalability, load balancing, and component management. The application server may be any appropriate server including a Microsoft Enterprise Services or any other appropriate application server. As shown in FIG. 2, the application server 440 may include a protocol library 442 which may accept requests from the protocol interface 434 of the web server 420. The application server 440 may also include a remote procedure call (“RPC”) library 444 which may include a library of requests which may be used to distribute computing functions. As an alternative, the application server may include a web service provider application in place of the RPC library 444. The application server 440 may also include enterprise software 446 which may be provided under a software architecture such as the Microsoft component object model interface (COM+) or any other appropriate architecture. The enterprise software 446 may implement the processing of the web site such as sales applications, brokerage applications, and customer service applications. The application server 440 may also include an operating system 448. The application server 440 may interface with a database server 460 through a database client interface 450. The configuration parameters for the application server components may include application pool size, object pool size, idle time management, memory limits, the operating configuration parameters of virtual memory allocation, thread scheduling algorithms, virtual memory allocation, thread scheduling algorithms and/or any other suitable parameter.

The database server 460 may accept requests for stored information from the application server and return the requested data to the application server. As shown in FIG. 2, the components of a database server 460 may include a database protocol 462, a query engine 464 which processes the information queries, an operating system 468, and a storage engine 466 which retrieves the correct information from a database 470. The components of the database server may have any appropriate configuration parameter including virtual memory allocation, thread scheduling algorithms, the database protocol type, thread scheduling algorithms, number of dispatchers, minimum number dispatcher processes, maximum number dispatcher processes, configuration of temporary table space based on number of transactions and/or any other suitable configuration parameter. For example, the database protocol type may be a value or selection in a set of values such as the set of remote procedure call protocol (“RPC”), transmission control protocol (“TCP”), and named pipes (“NP”).

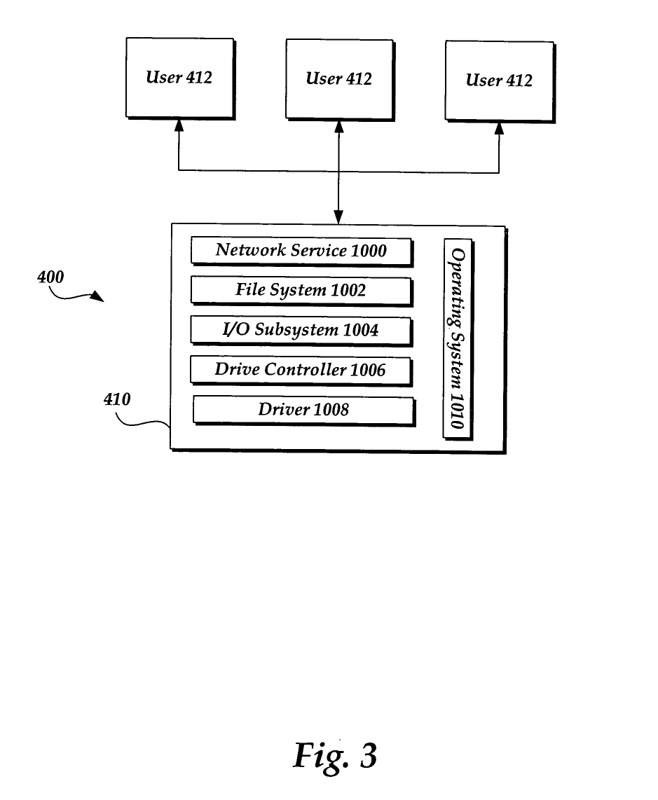

Alternative to, or in addition to, the computer system shown in FIG. 2, the computer system 400 may include a file server 410 which may provide file-handling and storage functions for shared resources for multiple host users 412 which are illustrated in FIG. 3. The file server 410 may also control access to the stored files in a database server 460 and may also control access to modify the stored files. As shown in the example file server of FIG. 3, the file server 410 may include a network service 1000, a file system 1002 such as Microsoft® Windows NT® file system available from the Microsoft Corporation of Redmond, Wash., an input/output subsystem 1004, a drive controller 1006, a driver 1008 which may be vender supplied, and an operating system 1010. File servers are known in the art and may include Microsoft WINDOWS SERVER 2003. The file server 410 may have a variety of configuration parameters which may include any combination of paged pool size, disable last access, virtual memory allocation, thread scheduling algorithms, the database protocol type, thread scheduling algorithms, number of dispatchers, minimum number dispatcher processes, maximum number dispatcher processes, configuration of temporary table space based on number of transactions and/or any other suitable configuration parameter.

To tune the computer system 400 illustrated in FIG. 1, the various configuration parameters of the components of the computer system may be adjusted to modify the functionality of the associated component. All or some portion of the exposed configuration parameters of the computer system components may be adjusted to tune the computer system as a whole. The configuration parameters may be automatically modified and applied to the computer system by an actuator processor 300. For example, the actuator processor 300 may run a script which replaces a present value of a configuration parameter with a new selected value of the configuration parameter. More particularly, the actuator processor 300 may use COMAdmin objects to change the COM+ configuration parameters, use a FileSystemObject to replace the current ASP.NET (424) settings in a web.config file with new ASP.NET settings embodied in a new web.config file, and/or may use any suitable utility to modify registry settings. After applying the values to the configuration parameters, the actuator processor 300 may run a reset application to ensure that all value settings have been accepted and will be honored. As shown in FIG. 1, the selected tunable computer system configuration parameters are illustrated collectively and may be given new selected values 582 over link 580. The new, selected configuration parameter values 582 are determined by the optimizer engine 200 and are received by the actuator processor 300 over link 584.

The optimizer engine 200 may optimize or improve the settings for the configuration parameters according to a predefined optimization algorithm such that the computer system 400 as a whole may be tuned for a particular operating environment. Although it is to be appreciated that many different optimizing algorithms may be suitable for optimizing the configuration parameters for the computer system components, one suitable optimization algorithm may include a genetic algorithm. The optimizer engine 200 may be described in the general context of computer-executable instructions, such as program modules, executed by one or more computers or other devices. Generally, program modules include routines, programs, objects, data structures, and the like that perform particular tasks or implement particular abstract data types. Typically, the functionality of the program modules may be combined or distributed as desired in various embodiments.

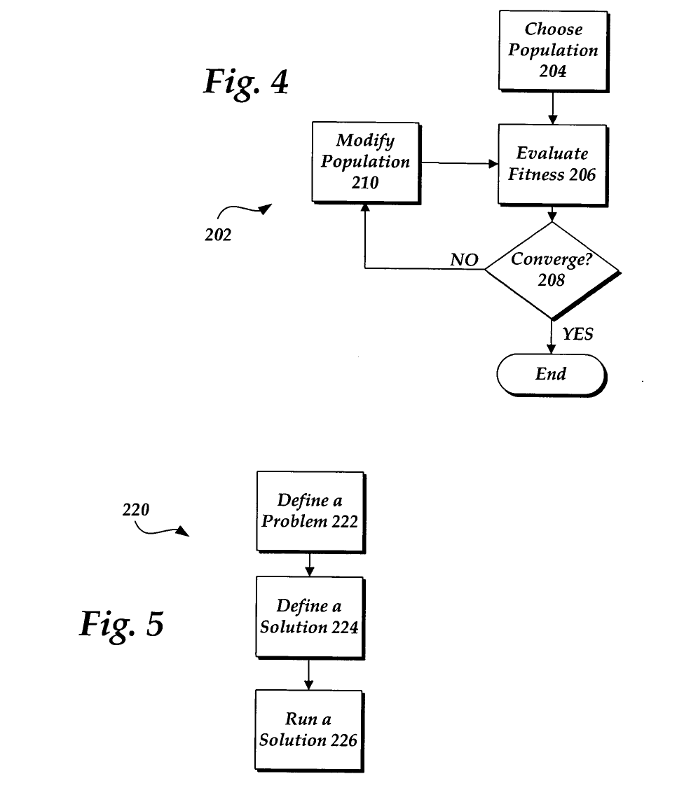

Genetic algorithms may be used in search and optimization problems. More particularly, genetic algorithms may mimic natural evolutionary patterns to some degree in order to find individuals that meet a desired goal. FIG. 4 illustrates a typical cycle 202 of a genetic algorithm process as known in the prior art. The genetic algorithm chooses 204 an initial population. For example, multiple individuals may be determined with random or default characteristics or configurations. The genotype of an individual in the population is the set of information that makes up a potential solution, whereas the phenotype of a particular individual is the particular set of configuration values interpreted from the given genotype for that individual resulting in ‘observable’ traits of the individual. The genetic algorithm process then evaluates 206 the fitness of that population. If the population meets 208 selected convergence parameters, then the population has been optimized. Otherwise, the genetic algorithm modifies 210 the genotype of the individuals in the population based upon the population of search points using selective reproduction (based on fitness) and applying operators which may include cross-over and/or mutation processes which affect the genotype. More particularly, each modified individual of the population may depend on multiple individuals in the previous population. The new population is then evaluated for fitness, and the cycle is continued until the convergence parameters are met.

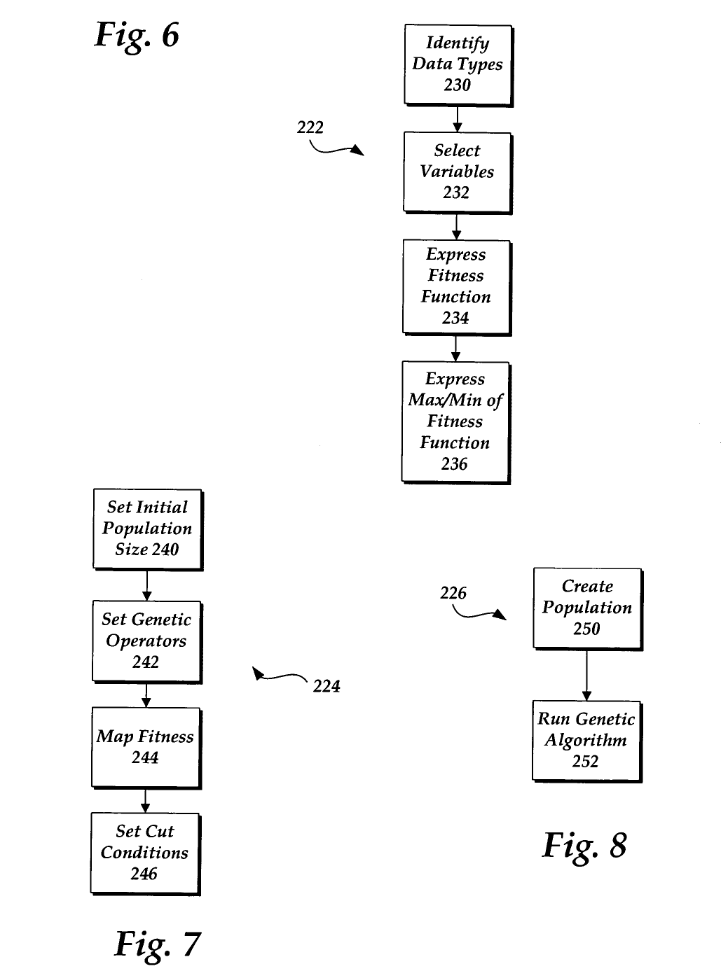

FIG. 5 illustrates phases of an example process 220 to apply a genetic algorithm process to optimizing the configuration parameters of the components of a computer system. Initially, the problem must be defined 222, the solution defined 224, and then the solution run 226. Each of these phases is discussed in more detail with reference to FIGS. 6-8.

FIG. 6 illustrates example steps in the process of defining 222 the problem (shown in FIG. 5). To understand the freedom and restrictions of a problem as well as the expected outcome, the data types for the problem may be identified 230 and variables that belong to certain data types may be selected 232, automatically and/or manually by the user. This defines the genotype for a particular individual in a population. Each data type may be continuous, categorical, or any other appropriate data type. The possible values for a given data type may be bounded such as by having one or more boundary limits in a range of values, classified such as a value or selection in a given set of discrete choices, or have any other suitable data value domain. The fitness function may then be expressed 234 as a transformation of the selected variables and other context information into a measurable attribute of the system being optimized. The transformation, in some cases, may include a generic function, script, program or object accepting the variables and context information as an input or the transformation may be a set of rules such as a set of IF-THEN statements. For the example shown in FIG. 1, the fitness function of the optimizer engine 200 which transforms the configuration parameters into a measurable attribute is the computer system 400 or an appropriate simulator thereof. At step 236, the desire to maximize or minimize the fitness function is expressed. In this manner, an individual of a population is a representation of a potential solution. More particularly, an individual may be a set of values for a selected set of configuration parameters which determine a specific performance of the computer system 400.

Returning to FIG. 1, the optimizer engine 200 may communicate with an optimizer database 250 which may store commonly used data types, operators, cut conditions, and/or fitness mappings. These stored example genotypes, data types, operators may be made available to a user through a suitable user and/or program interface. The database may also be used to save specific problem definitions such as the phenotype, genotype and/or the problem solutions such as the response data for each generational population and/or for the optimized population of a particular computer system and environment.

FIG. 7 illustrates example steps in the process of defining 224 a solution setting (shown in FIG. 5). A solution setting may be a set of parameters that will tell a genetic algorithm how to operate on the selected variables. Typical solution settings may include, but are not limited to, setting 240 a population size. There may be any number of populations having any number of individuals within the population, and these elements may be determined based on many factors. For example, a large population may allow more genetic material, and consequently may allow more genetic combinations; however, a large population may also require more time to evaluate the fitness for each generation. Similarly, a small population may not allow as many genetic variations within a population, however, the evaluation time may be more limited as well which may allow for more generations. In the examples described below, the population is generally a single population of a fixed size.

Returning to FIG. 7, genetic operators may be set 242 to determine how the variables (parts of a phenotype, ultimately expressed in the genotype) may be modified in each generation of the population and how often they will be modified by that method. Typical genetic operators may include cross-over, reproduction, and mutation. Cross-over is generally an operation which genetic material (or value) from one chromosome (or part of the genotype) will cross-over to another chromosome (typically the genotype of another individual). Reproduction may be sexual or asexual. Sexual reproduction may create a new individual based upon a mixture of the parents and asexual reproduction typically results in an offspring which may be genetically identical to the single parent. A mutated offspring has a randomly modified genotype. Moreover, custom operators may be developed based upon domain knowledge of the configuration parameter combinations. For example, some configuration parameters may be known to be have a bad fitness and/or some configuration parameters may be known to affect the computer system response in a mathematical fashion, such as quasi-linearly. Custom operators may be developed to avoid these known configuration parameter combinations which result in bad fitness evaluations.

The selection of which individuals of the population will be modified may be based upon a fitness evaluation of that individual, fitness comparison in a subgroup of individuals, and/or a random selection. For example, an aggressive fitness mapping may select for recombination only those individuals which meet a high level of fitness. The genetic operators may also be set with an associated probability of activation with a particular individual and/or other operator-specific parameters such as probability of operating on a particular portion of the genotype or phenotype of an individual. For example, the probability of mutation may be low since recombination operators such as cross-over and reproduction may sufficiently converge if the initial population is disperse. The results of the fitness function (step 234 above) may be mapped 244 to an individual fitness using an objective-fitness transformation expression, e.g., the raw measurements may be mapped to a fitness score to result in a fitness scaling. For example, the measured attribute of the system may be a time to process a specified number of transaction and the fitness result of each individual phenotype may differ by only a few milliseconds of time. Thus, to perform fitness scaling, each result could be mapped to a fitness score, e.g., 10, 15, and 20, so in a successive generation, the best individual may have a greater probability of being selected as compared the worst individual, and a greater probability of selection as compared to a selection based on the raw fitness measurements. To save computing time, the fitness results may be cached, for example in the optimizer database 250, since it may be assumed that in the same population, the evaluation of two individuals with identical phenotypes will result in identical fitness values.

Returning to FIG. 7, the cut conditions of the genetic algorithm cycle may also be set 246 which determine when the optimization cycle will stop. In some cases, the cut condition may be a percentage of the population being identical, a relative jump in fitness from one population to another, a percent of individual phenotypes being close but not identical in a single population, or all fitness scores of a population being within a range of a predetermined value or each other. In the example discussed further below, the cut condition percentage is 100% and likeness defined as a phenotypic Hamming distance of zero.

The processes of FIGS. 5-8 may be applied to the computer system 400, shown in FIG. 1. To select 230 the data types, the components of the computer system 400 shown in FIGS. 1-3 must be determined. As noted above, these components may include, but are not limited to, a computer processing unit, an application, a storage unit, a communication port and/or other networking component, an operating system, and/or other hardware and software components in a multi-component computer system. Each component may have at least one configuration parameter which can be thought of as a knob that may change how the component operates without changing the semantics of the application. The data type for each selected configuration parameter may be set.

For example, Microsoft IIS server software includes a parameter which allows the tuner to specify the number of threads the server will use to service an incoming request. Thus, the selected tunable parameters for a multi-purpose computer system hosting a web site may include the number of IIS threads. In one example, the number IIS threads may be bounded by the range of 1 to 31 and may have 16 samples. Another tunable parameter for a web site computer system may include a transaction setting for a product query. This is typically a binary setting (0 or 1) which may determine whether the catalog query uses Microsoft Distributed Transaction Coordinator transactions. A further tunable parameter may be a transaction setting for the purchase operation. More particularly, operations may be set as transactional or non-transactional to track performance or success of accomplishing the transaction and not just the speed of process. Another tunable configuration parameter may include a COM+ Authentication level which determines the level of authentication for the application. The COM+ parameter may have four categories including NONE, CONNECT, CALL, or PACKET_PRIVACY. The tunable configuration parameters may also include a queued purchase operation which may have a binary setting (0 or 1) which determines whether the purchase operation was completed synchronously or asynchronously through COM+ queued components. Another configuration parameter may include a database protocol setting which may let the optimizer select the protocol for the database server. Possible categorical values for the database protocol setting may include TCP/IP, named pipes, or any other suitable protocol. The database access type may be another tunable configuration parameter and may let the optimizer select the access type to the database server such as a Microsoft SQL server through native OleDB or Microsoft Open Database Connectivity (“ODBC”). Another tunable configuration parameter may include a COM+ activation setting which may allow the optimizer to control whether the components are instantiated by the ASP pages locally on the web server or on a middle tier box. In this example, the tunable configuration parameters may be compressed into a total of 12 bits of which there are a possible 4096 possible different individuals with the selected configuration parameters (genotype).

All of the available parameters of each computer system component may be selected as an optimizable variable since the optimizer engine 200 using a genetic algorithm may self-determine which of the configuration parameters affect the computer system response. However, to limit the processing time, the number of configuration parameters within each individual (the genotype) may be limited to those which are known to affect performance or another measurable attribute of the computer system.

FIG. 8 illustrates example steps in a process of running a solution 226 (shown in FIG. 5). Running a solution may entail creating 250 a population of individuals based on the problem defined at step 222. The genetic algorithm may then be run 252 using the iterative steps of evaluation 206, convergence testing 208, and modification 210 shown in FIG. 4 of the prior art. More particularly, the genetic operators set at step 242 may be used to modify 210 the population, the mapping of the fitness evaluation may be used to evaluate 206 the population, and the cut conditions may be used to determine 208 if the population has converged on a solution. In this manner, the basic runtime is a loop that comprises generating new and improved individuals based on fitness of the prior population, and the loop stops when the resulting population meets some predetermined fitness and/or end condition.

Returning to FIG. 1, to determine the computer system response to the configuration parameter values selected by the optimizer 200 and input by the actuator 300, the monitoring engine 500 starts and stops a testing harness 600 and measures the response of the computer system 400. The testing harness 500 may provide a set of inputs 588 to the computer system over link 590 and may simulate typical or stressed operation inputs to an operational computer system 400. More particularly, in the example shown in FIG. 1, the testing harness 500 provides an input to the computer system which simulates the operating environment of host users accessing the web site, making requests, and completing purchases. To simulate the e-commerce operational environment, the testing harness may include requesting a catalog page, such as an active server page (“ASP”) 432 which simulates ‘a user’ browsing through pages of products. For example, the catalog ASP may request the web server to retrieve two hundred random products from a database of thousands of products. The product browsing may be accompanied by requests to access the database system 460. The testing harness 500 may also include a simulation of purchasers completing the checkout process, such as via a purchase ASP. For example, the purchase ASP may indicate ten items for the order and then make a request on the web server and application server to store the actual purchase and all the purchased items. In one example for evaluation of a particular configuration parameter input (part of the phenotype of an individual in a population), the testing harness 600 may provide three catalog browses and one purchase with thirty concurrent threads for a period of two minutes. It is to be appreciated that any level of stress testing, period of stress testing, and/or testing harness simulator may be selected as appropriate for the providing operating environment inputs to the computer system 400 and the response to be measured by the monitoring engine 500.

Using the configuration parameter values 582 input from the actuator processor 300 and operational inputs 588 from the testing harness 600, the computer system 400 shown in FIG. 1 may provide a response 586 which is then measured and recorded by the monitoring engine 500 over link 594. In one example, the performance of the computer system 400 may be measured. More particularly, the monitoring engine may measure the average number of requests per second processed by the computer system 400 in response to the inputs from the testing harness 600 and the optimizer engine 200 through the actuator processor 300. In other cases, the monitoring engine may measure the scalability of the computer system such as by measuring how the system behaves with a growing number of users. The monitoring engine may measure the security of the system with any suitable security metric including attack surface area, attack depth, ability to reach ‘sensitive points’ or ‘honey pots’ in the system, and the like. The measurable metric may be optimized using any appropriate configuration parameters such as the authentication type, coarseness of the authentication, the encryption algorithm, and/or the digital signatures used and verified, and/or any other suitable configuration parameter.

The monitoring engine 500 may also provide a user interface which allows the user to control the optimizer process as it is running, control the testing harness as it is running, observe the optimizer current status, and/or observe the testing harness inputs to the computer system. For example, the monitoring engine may display the generation or cycle number of the population being determined, the number of individuals in the population, the average population statistics such as percent convergence, and/or the configuration parameters values selected for the average population and/or for each individual in the population. The output response of the computer system 586 may be measured by the monitoring engine and then sent to the optimizer 200 for evaluation by the optimizer over link 592. The optimizer engine 200 and/or monitoring engine may store selected evaluation data in a database, such as optimizer database 250 for creation of and comparison with the nest generated population.

To test a complete population, the optimizer engine 200 may then select the next individual to test, e.g., another set of configuration values (phenotype of an individual), and provide those values to the actuator processor 300 to be applied to the computer system 400 with a round of operation inputs 588 from the testing harness 600, and that response measured. When the computer system response 586 to each individual in one generation of a population is measured, the optimizer engine 200 may then determine if the solution has converged. If not, the optimizer engine 200 may determine a new population to test and restart the cycle.

As shown in FIG. 1, the actual or production computer system 400 may be used to provide not only a measurable response to the input configuration parameters and the operational inputs, but also may allow a complete and true test response of the computer system in situ. For example, computer system 400 may provide the test response to the optimizer engine as well as may provide the actual function(s) of the computer system in operation. Moreover, since only the exposed configuration parameters are modified in the computer system during the optimization, the inner workings of the computer system do not need to be known or simulated by the tuning system 100. However, testing the tuning system 100 on the actual computer system may, in some cases be considered too burdensome in view of existing loads on the computer system or the risk of a computer system failure to high to modify the configuration parameters of an operational system 400. In that case, a computer system simulation, testing system, or staging system may replace the computer system 400 shown in FIG. 1. Alternatively, if the computer system 400 has multiple identical sets of components, only one or more of the identical sets of components may be used to provide a system response. For example, one web server in a farm may be used in the tuning system 100 to provide a valid tuning response to configuration parameter inputs. The optimized configuration parameter settings may be rolled out to the other identical web servers in the farm in a controlled fashion to limit the risk of failure.

The tuning of a computer system may be applied to the computer system 400 at discrete times in the computer system lifetime and/or continuously. For example, the tuning system 100 may be applied to the computer system 400 at implementation. More particularly, the tuning system may be used to explore configurations and implementation changes to optimize the application. Example optimization attributes at the implementation stage may include finding the optimal protocol or transport formation such as XML or binary; balancing the number of threads for services; determining data access strategies and/or cost of wrappers; and/or determining major tuning options for services such as Microsoft EXCHANGE and/or SQL server. The tuning system 100 may also be implemented at the documenting stage of the computer system lifetime. For example, the documenting stage presents a major opportunity since the tuning or deployment guides are being created for a product. The tuned configuration may touch the application settings, server settings, operating system, network parameters, and the like.

Deployment of an application in staging may also be an opportunity to apply the tuning system 100. For example, the customer, the vendor of the computer system, or the vendor of the optimizer engine may apply the tuning system 100 to the actual customer computer system in situ to find and document the optimal performance on-site. In this manner, the computer system technician may find and document the settings for good performance which are relevant to the specific computer system in use. In some cases, it may be appropriate for the vendor or other tuning technician to tune the computer system 400 before sale to the customer or provide example sets of tuned configuration parameters as suggested configuration settings.

To address operational and use pattern changes to a computer system, the tuning system 100 may be applied periodically, from time to time or continuously to the operational system or during production. To mitigate the risks of failure in tuning an operational computer system, the tuning system may be applied to only a portion of the computer system at a time. For example, as discussed above, the tuning system may be applied to only one of a plurality of identical or similar computer system components to limit exposure of the operational system to the changing configuration parameters during the tuning system optimization.

In some cases, the tuning system 100 may be provided to a customer for operational tuning on the computer system 400. Alternatively, the optimizer engine 200, actuator processor 300, monitoring engine 500, simulated computer system 400, and/or testing harness 600 may be centrally located and accessible by an operational computer system 400. More particularly, the new configuration parameters 582 and operational inputs 588 may be provided to the computer system 400 shown in FIG. 1 over a communication network such as the Internet. In this manner, the computer system 400 may remotely access the tuning system 100 when optimization of configuration parameters is desired.

It may be appropriate in some cases to tune the optimizer engine 200 itself as part of the tuning process of a computer system. In this manner, the configuration parameters selected, the reproduction operators, the probability of reproduction application, fitness mapping, and the like may be optimized as part of the genotype of a population individual for a particular application to a computer system 400.

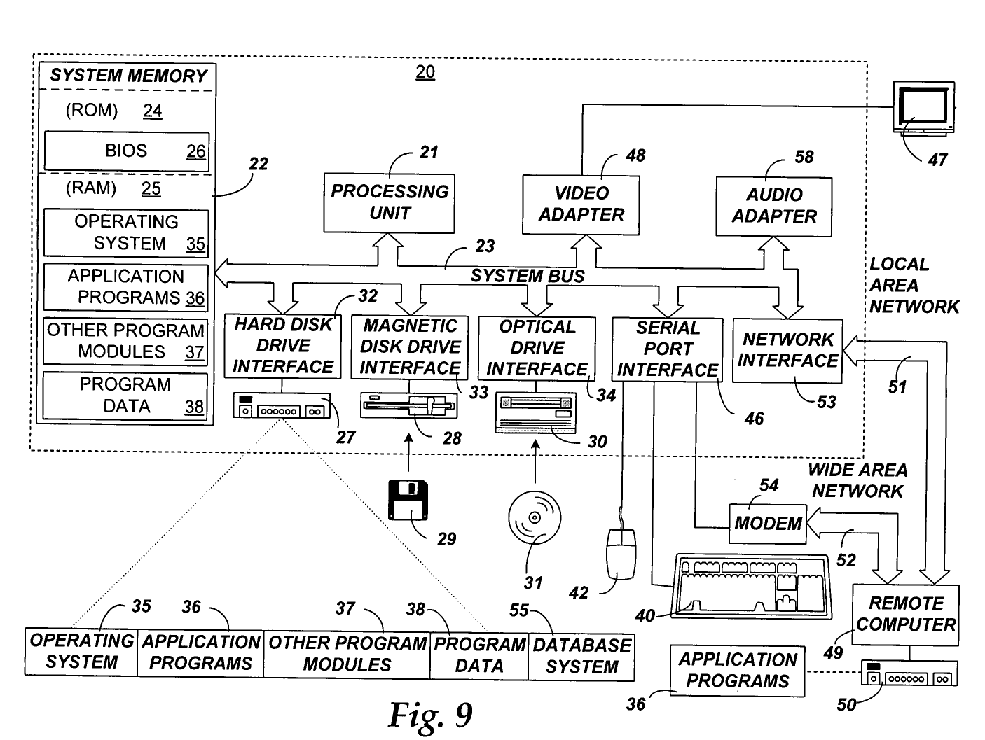

FIG. 9 illustrates an example of a suitable computing system environment 900 on which any combination of the computer system 400, optimizer engine 200, actuator processor 300, monitoring engine 500 and testing harness 600 may be implemented. The computing system environment 900 is only one example of a suitable computing environment and is not intended to suggest any limitation as to the scope of use or functionality of the tuning system. Neither should the computing environment 900 be interpreted as having any dependency or requirement relating to any one or combination of components illustrated in the exemplary operating environment 900.

The tuning system is operational with numerous other general purpose or special purpose computing system environments or configurations. Examples of well known computing systems, environments, and/or configurations that may be suitable for use with the tuning system include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, networking devices including routers, switches, and firewalls and the like, storage systems such as NAS SAN devices, and the like.

The tuning system may be described in the general context of computer-executable instructions, such as program modules, being executed by a computer. Generally, program modules include routines, programs, objects, components, data structures, etc. that perform particular tasks or implement particular abstract data types. The tuning system may also be practiced in distributed computing environments where tasks are performed by remote processing devices that are linked through a communications network. In a distributed computing environment, program modules may be located in both local and remote computer storage media including memory storage devices.

With reference to FIG. 9, an exemplary system for implementing the tuning system includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through an non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through a output peripheral interface 990.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

While the preferred embodiment of the invention has been illustrated and described, it will be appreciated that various changes can be made therein without departing from the spirit and scope of the invention.

1. A method of tuning a multi-purposed computer system comprising:
(a) optimizing a plurality of configuration parameters of the multi-purposed computer system using a genetic algorithm, the multi-purposed computer system comprising a plurality of computer system components, the plurality of configuration parameters including at least a first configuration parameter of a first computer system component and a second configuration parameter of a second computer system component.

2. The method of claim 1, wherein optimizing comprises optimizing the speed of performance of the computer system.

3. The method of claim 1, wherein optimizing comprises optimizing the security of the computer system.

4. The method of claim 1, wherein optimizing comprises optimizing the scalability of the computer system.

5. The method of claim 1, wherein the plurality of computer system components includes at least two of a computer processing unit, an application, a storage unit, a communication port, and an operating system.

6. The method of claim 1, wherein at least two of the plurality of computer system components are heterogeneous.

7. The method of claim 1, wherein the plurality of computer system components includes a first application and a second application.

8. The method of claim 7, wherein the first application and the second application are heterogeneous.

9. The method of claim 8, wherein the first application and the second application are produced by different entities.

10. The method of claim 1, further comprising automatically selecting the configuration parameters to optimize based on effect on the optimizing.

11. The method of claim 10, wherein optimizing includes modifying the relevant configuration parameters and sending the modified configuration parameters to the computer system.

12. The method of claim 1, wherein the computer system includes a predetermined topology indicating a communication link between at least two components of the computer system.

13. A computer readable medium having computer executable steps for performing the steps recited in claim 1.

14. A computer readable medium having computer-executable instructions for performing steps comprising:
(a) using a genetic algorithm, generating a first configuration parameter for a first software component of a computer system;
(b) using the genetic algorithm, generating a second configuration parameter for a second software component of the computer system;
(c) based on the first and second configuration parameters, receiving results data from the computer system;
(d) evaluating the results data;
(e) using the genetic algorithm, modifying at least one of the first configuration parameter and the second configuration parameter to tune the computer system.

15. The computer readable medium of claim 14, wherein the computer system is a multi-purposed computer system.

16. The computer readable medium of claim 14, wherein the computer system includes a predetermined topology indicating a communication link between at least two components of the computer system.

17. The computer readable medium of claim 14, wherein the second configuration parameter includes a plurality of configuration parameters of the second software component, and the first configuration parameter is different from each of the plurality of configuration parameters of the second software component.

18. The computer readable medium of claim 14, wherein the first software component is different from the second software component.

19. The computer readable medium of claim 18, wherein the second configuration parameter includes a plurality of configuration parameters of the second software component, and the first configuration parameter is different from each of the plurality of configuration parameters of the second software component.

20. The computer readable medium of claim 18, wherein the first configuration parameter is identical to the second configuration parameter.

21. A system for tuning a multi-purposed computer system, the system comprising:
(a) a first computer system component having a first configuration parameter and a first purpose;
(b) a second computer system component having a second configuration parameter and a second purpose, wherein the second purpose is different from the first purpose;
(c) an actuator processor for applying the first configuration parameter to the first computer component and applying the second configuration parameter to the second computer component;
(d) a testing harness having an output for generating operational inputs for at least one of the first computer system component and the second computer system component;
(e) a genetic algorithm optimizer component comprising a genetic algorithm having an output for optimizing the first and second configuration parameters based on the output of the stress testing component;
(f) a monitoring engine for receiving the optimized first and second configuration parameters.

22. The computer readable medium of claim 21, further comprising an actuator component for applying the configuration parameters to the first computer system component and the second computer system component.

23. The computer readable medium of claim 21, wherein the genetic algorithm optimizer includes a population generator component, a population evaluator component, and a stop condition comparator component.

24. The computer readable medium of claim 21, wherein the first configuration parameter is different from the second configuration parameter.

25. The computer readable medium of claim 21, wherein the first computer system component is one a group consisting of a computer processing unit, an application, a communication port, and an operating system, and the second computer system component is a storage unit.

26. A method of tuning a computer system having a plurality of computer system components, the method comprising:
(a) generating a first set of values of a plurality of configuration parameters for the plurality of computer system components;
(b) applying the values to the plurality of computer system components;
(c) determining a first response of the computer system based on the first set of values;
(d) using a genetic algorithm, generating a second set of values for the plurality of configuration parameters for the plurality of computer system components;
(e) determining a second response of the computer system based on the second set of values;
(f) evaluating the second response for fitness;
(g) applying the second set of values to the plurality of computer system components.

27. The method of claim 26, wherein the computer system is a multi-purposed computer system.

28. The method of claim 26, wherein the computer system includes a predetermined topology indicating a communication link between at least two computer system components of the computer system.

29. The method of claim 26, wherein the configuration parameters includes a first configuration parameter of a first computer system component and a plurality of configuration parameters of a second computer system component, the first configuration parameter being different from each of the plurality of configuration parameters of the second software component.

30. The method of claim 26, wherein determining the first response of the computer system includes generating simulated operational inputs to the computer system.
